(19) United States
(12) Patent Application Publication
(10) Pub. No.: US 2015/0146559 A1
(43) Pub. Date: May 28, 2015

(54) TRANSMISSION APPARATUS, RECEPTION APPARATUS, TRANSMISSION METHOD, AND RECEPTION METHOD

(71) Applicant: Sharp Kabushiki Kaisha, Osaka-shi, Osaka (JP)

(72) Inventors: Ryota Yamada, Osaka-shi (JP); Kazunari Yokomakura, Osaka-shi (JP); Takashi Yoshimoto, Osaka-shi (JP); Kozue Yokomakura, Osaka-shi (JP); Katsuya Kato, Osaka-shi (JP)

(21) Appl. No.: 14/405,179

(22) PCT Filed: Jun. 3, 2013
(86) PCT No.: PCT/JP2013/065332

§ 371 Date: Dec. 3, 2014

(30) Foreign Application Priority Data
Jun. 6, 2012 (JP) 2012-128551

(51) Int. Cl. H04L 25/02; H04L 5/00

(52) U.S. Cl. CPC H04L 25/0224; H04L 5/0048
USPC 370/252

(57) ABSTRACT

A reference signal generation unit 105 generates a reference signal and inputs it to resource-mapping units 106-1 to 106-T. There may be a plurality of types of reference signals depending on purposes. In the present disclosure, only a user-specific demodulation reference signal (DM-RS) is described. The resource-mapping units 106-1 to 106-T map DM-RS's and an input from the precoding unit 104 to a resource such that they are orthogonal between transmitting antennas and between transmission points.

### TECHNICAL FIELD

The present invention relates to a transmission apparatus, a reception apparatus, a transmission method, and a reception method, for performing transmission by coordination of a plurality of transmission points.

### BACKGROUND ART

In general, in wireless communication, to allow a reception apparatus to demodulate a signal transmitted by a transmission apparatus, the reception apparatus needs to estimate a channel between the transmission apparatus and the reception apparatus. The channel estimation is performed using a signal (for example, a reference signal) known at the transmitting and receiving sides. For example, in a LTE-A (Long Term Evolution-Advanced) mobile communication system, which is a next-generation mobile communication system, a user-specific demodulation reference signal (UE-specific reference signal: DM-RS) is used. The DM-RS is a reference signal for use in demodulating a data signal (PDSCH: Physical Downlink Shared Channel), and thus DM-RS's are allocated only in resource blocks to which PDSCH is allocated.

FIG. 7 illustrates an example of a manner of mapping DM-RS's. In the example illustrated in FIG. 7, a manner of mapping DM-RS's in one resource block is illustrated. In this example, one resource block includes 12 subcarriers and 14 OFDM (Orthogonal Frequency Division Multiplexing) symbols. The resource block includes resource elements each including one subcarrier and one OFDM symbols. Hatched resource elements denote resource elements in which DM-RS's are allocated. LTE-A supports use of up to eight transmitting antennas, which are respectively denoted by antenna ports 7 to 14. In hatched resource elements located in an upper right corner, DM-RS's of antenna ports 7, 8, 11, and 13 are code-multiplexed onto four resource elements. In hatched resource elements located in a lower right corner, DM-RS's of antenna ports 9, 10, 12, and 14 are code-multiplexed onto four resource elements. Note that in a case where the number of transmitting antennas used is equal to or less than two, PDSCH is allocated, instead of DM-RS, in the hatched resource elements located in the lower right corner.

As described above, each reception terminal (UE: User Equipment) estimates a channel, by using a DM-RS, between each transmitting antenna and the receiving antenna, and performs demodulation.

NPL 1 describes a technique associated such DM-RS's.

### CITATION LIST

### Non Patent Literature

NPL 1: 3GPPTS36.211V10.4.0, (Release 10), December, 2011.

### SUMMARY OF INVENTION

### Technical Problem

In future wireless communication systems, it will be needed to further further increase communication speed and throughput for a cell edge user. In such a future situation, a technique such as a CoMP (Coordinated Multiple Points) technique, a Het.Net (Hoterogeneous Network) technique, or the like will be important to achieve coordination among a plurality of transmission points (base stations, relay stations, and the like). In the CoMP technique, the Het.Net technique, and the like, interference (for example, intercell interference) among a plurality of transmission points may cause a problem. At present, to handle intercell interference, interference coordination is performed such that an equal frequency is not assigned to users between which intercell interference can occur. However, to achieve high-speed data transmission and to improve the throughput, it is necessary to well suppress intercell interference even in a situation in which intercell interference may occur. To achieve this requirement, it is desirable to be capable of estimating channel information between each transmission point and a reception terminal. However, in the technique associated with DM-RS's disclosed in NPL 1, overlapping of signals can occur among transmission points, which makes it impossible to accurately determine channel information between each transmission point and the reception terminal. Therefore, there is a problem that it is impossible to well suppress intercell interference and it is difficult to improve the throughput.

In view of the above, it is an object of the present invention to provide a transmission apparatus, a reception apparatus, a transmission method, and a reception method, that make it possible to well suppress intercell interference.

### Solution to Problem

The present invention provides a transmission apparatus configured to perform a transmission to a reception apparatus by coordination of a plurality of transmission points, including a reference signal generation unit configured to generate a first reference signal that is a user-specific reference signal to be transmitted to a reception apparatus that is an apparatus to communicate with, and a resource-mapping unit configured to map the first reference signal and a data signal to time and frequency resources, wherein the resource-mapping unit performs the mapping such that the first reference signal is orthogonal to a second reference signal that is a user-specific reference signal transmitted by the plurality of transmission points.

In the transmission apparatus according to the present invention, the resource-mapping unit may map the first reference signal such that the first reference signal and the second reference signal are code-multiplexed.

In the transmission apparatus according to the present invention, the resource-mapping unit may set a resource to which the second reference signal is mapped such that the resource is a carrier hole.

In the transmission apparatus according to the present invention, the resource-mapping unit may map the first reference signal such that the first reference signal and part of the second reference signal are code-multiplexed and the resource-mapping unit may set a resource to which the other part of the second reference signal is mapped such that the resource is a carrier hole.

In the transmission apparatus according to the present invention, the resource-mapping unit may map the first reference signal such that the first reference signal and a second reference signal transmitted by part of the plurality of transmission points are code-multiplexed and the resource-mapping unit may set a resource to which the other second reference signals are mapped such that the resource is a carrier hole.

In the transmission apparatus according to the present invention, the resource-mapping unit may use a code with a length equal to or greater than 8.

In the transmission apparatus according to the present invention, the same precoding may be used for the first reference signal and a data signal demodulated using the first reference signal.

The present invention also provides a reception apparatus configured to receive a signal transmitted by coordination of a plurality of transmission points, including a channel estimation unit configured to estimate a channel between the respective transmission points and the reception apparatus by using a user-specific reference signal transmitted by the plurality of transmission points.

The present invention also provides a transmission method, in a transmission apparatus configured to perform a transmission to a reception apparatus by coordination of a plurality of transmission points, including a step of generating a first reference signal that is a user-specific reference signal to be transmitted to a reception apparatus that is an apparatus to communicate with, and a step of resource-mapping the first reference signal and a data signal to time and frequency resources, wherein the resource-mapping step includes performing the mapping such that the first reference signal is orthogonal to a second reference signal that is a user-specific reference signal transmitted by the plurality of transmission points.

The present invention also provides a reception method in a reception apparatus configured to receive a signal transmitted by coordination of a plurality of transmission points, including a step of estimating a channel between the respective transmission points and the reception apparatus by using a user-specific reference signal transmitted by coordination of the plurality of transmission points.

### Advantageous Effects of Invention

According to the present invention, reference signals are orthogonal among transmission points, and thus it becomes possible to estimate a channel between each transmission point and a reception terminal. By feeding back a channel estimation value between the reception terminal and each transmission point estimated by the reception terminal to the transmission point, it is possible to improve the cell throughput.

### BRIEF DESCRIPTION OF DRAWINGS

FIG. 1 is a schematic block diagram illustrating a configuration of a transmission apparatus according to an embodiment.

FIG. 2 is a schematic block diagram illustrating a configuration of a reception apparatus according to an embodiment.

FIG. 3 illustrates an example of mapping DM-RS's in resource blocks such that the DM-RS's are orthogonalized by using diffusion codes.

FIG. 4 illustrates an example of mapping DM-RS's in resource blocks such that the DM-RS's are orthogonalized by time and frequency in addition to diffusion codes.

FIG. 5 illustrates an example of mapping DM-RS's in resource blocks such that 13th and 14th symbols are shortened thereby generating extra resource elements for use as carrier holes.

FIG. 6 illustrates an example of mapping DM-RS's in resource blocks such that hatched resource elements in a lower right corner are carrier holes.

FIG. 7 illustrates a conventional example of mapping DM-RS's in resource blocks.

### DESCRIPTION OF EMBODIMENTS

Embodiments of the present invention are described below with reference to drawings.

### First Embodiment

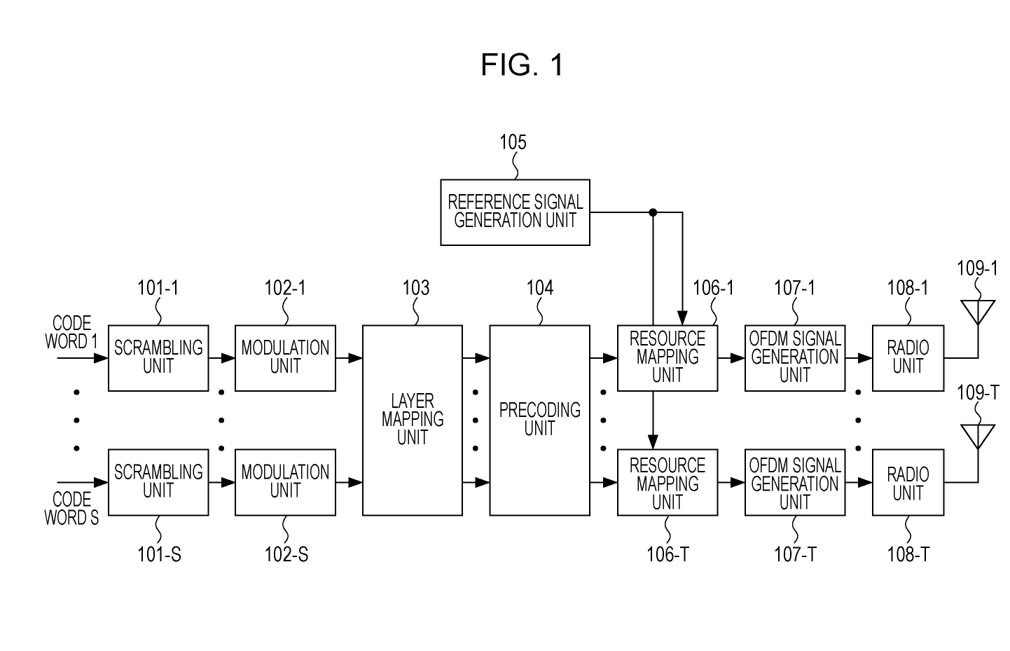

FIG. 1 is a schematic block diagram illustrating a configuration of a transmission apparatus according to a first embodiment. The transmission apparatus includes scrambling units 101-1 to 101-S, modulation units 102-1 to 102-S, a layer mapping unit 103, a precoding unit 104, a reference signal generation unit 105, resource-mapping units 106-1 to 106-T, OFDM signal generation units 107-1 to 107-T, radio units 108-1 to 108-T, and transmitting antennas 109-1 to 109-T.

The scrambling units 101-1 to 101-S perform scrambling based on respective IDs on code words 1 to S having data bits error correction coded using a convolutional code, a turbo code, an LDPC (Low Density Parity Check) code, or the like. The scrambled code words 1 to S are mapped by the modulation units 102-1 to 102-S to modulation symbols such as PSK (Phase Shift Keying) symbols, QAM (Quadrature Amplitude Modulation) symbols, or the like. The modulation symbols are mapped by the layer mapping unit 103 into layers for spacial multiplexing. LTE-A supports use of up to 8 layers, and one code word is mapped up to 4 layers.

An output from the layer mapping unit 103 is precoded by the precoding unit 104 thereby generating signals for the respective transmitting antenna ports. The precoding may be applying a weight generated by coordination of a plurality of transmission points, applying a weight that makes it easy to make MIMO separation or applying a weight that allows it to improve reception SNR (Signal to Noise power Ratio). Note that an equal precoding weight is used for a DM-RS and a data signal decoded using this DM-RS.

Let T denote the number of transmitting antenna ports. The reference signal generation unit 105 generates a reference signal and inputs it to the resource-mapping units 106-1 to 106-T. A plurality of types of reference signals may be used depending on purposes, although in the present disclosure, only a user-specific demodulation reference signal (DM-RS) is described. The resource-mapping units 106-1 to 106-T map DM-RS's and an input from the precoding unit 104 to resources such that they are orthogonal between transmitting antennas and between transmission points. Note that the transmission points are transmission apparatuses such as base stations, a relay stations, and the like that perform coordinate communication. The resource-mapping will be described in further detail later.

Outputs from the resource-mapping units 106-1 to 106-T are subjected to an IFFT (Inverse Fast Fourier Transform) process and insertion of a cyclic prefix (CP) by OFDM (Orthogonal Frequency Division Multiplexing) signal generation units 107-1 to 107-T, and further subjected to a digital-to-analog conversion process, a filtering process, a frequency conversion process, and the like by the radio units 108-1 to 108-T. Resultant signals are transmitted from the transmitting antennas 109-1 to 109-T.

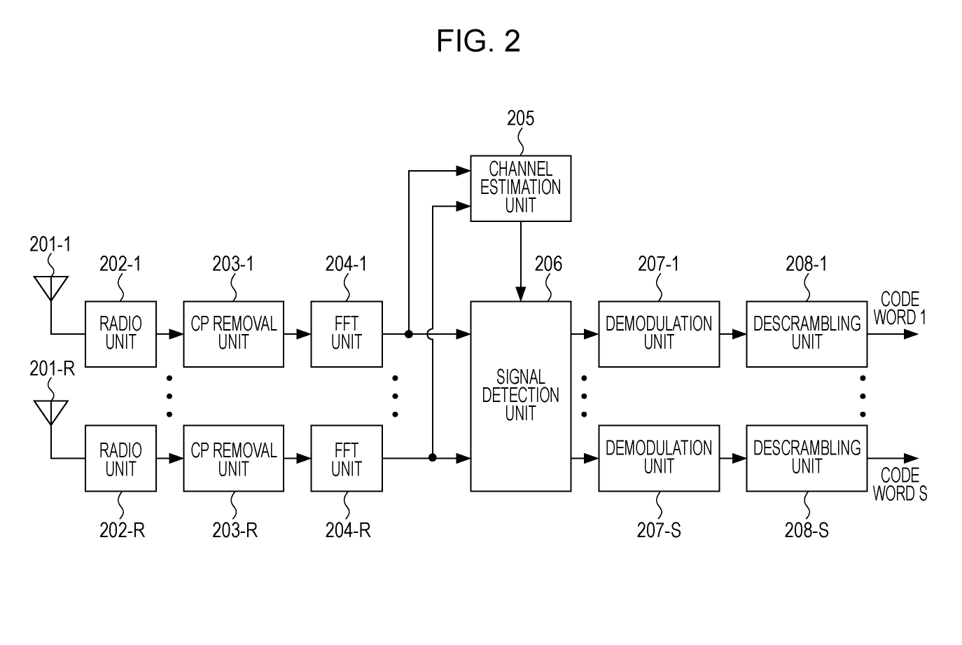

FIG. 2 is a schematic block diagram illustrating a configuration of a reception apparatus according to the present embodiment. The reception apparatus includes receiving antennas 201-1 to 201-R, radio units 202-1 to 202-R, CP removal units 203-1 to 203-R, FFT units 204-1 to 204-R, a channel estimation unit 205, a signal detection unit 206, demodulators 207-1 to 207-S, and descrambling units 208-1 to 208-S.

Received waves received via R receiving antennas 201-1 to 201-R are subjected to a frequency conversion process, a filtering process, an analog-to-digital conversion process, and the like performed by the radio units 202-1 to 202-R. As a result, baseband signals are generated. The baseband signals are subjected to a cyclic prefix removal process performed by the CP removal units 203-1 to 203-R, and further subjected to a time-frequency conversion process performed by the FFT units 204-1 to 204-R. The channel estimation unit 205 performs a channel estimation using the received DM-RS. The signal detection unit 206 performs, using a channel estimation value, suppression of intercell interference and MIMO separation. Thereafter, demodulation is performed by the demodulators 207-1 to 207-S, and descrambling is performed by the descrambling units 208-1 to 208-S. As a result, code words 1 to S are obtained.

Mapping of DM-RS's according to the present embodiment is described.

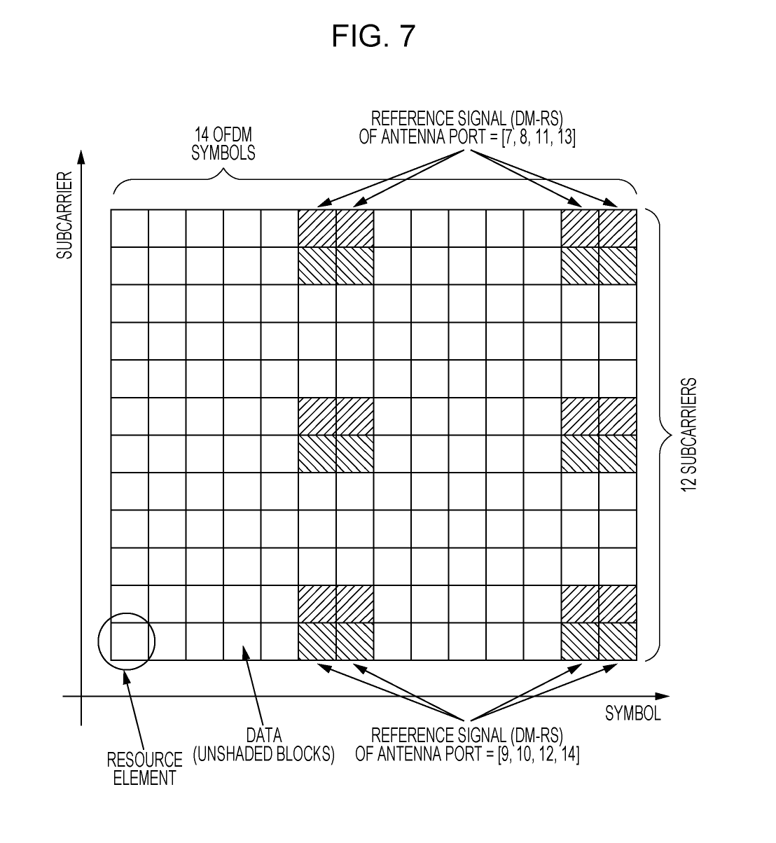

First, conventional mapping of DM-RS's is described. FIG. 7 illustrates a conventional manner of mapping DM-RS's in resource blocks. Here, it is assumed by way of example that one resource block includes 12 subcarriers and 14 OFDM symbols. The resource block includes resource elements each including one one subcarrier and one OFDM symbols. Hatched resource elements denote resource elements in which DM-RS's are allocated. Unhatched resource elements denote resource elements in which a data signal (PDSCH: Physical Downlink Shared Channel) is allocated. LTE-A supports use of up to 8 transmitting antennas, which are respectively denoted by antenna ports 7 to 14. In hatched resource elements located in an upper right corner, DM-RS's of antenna ports 7, 8, 11, and 13 are code-multiplexed onto four resource elements. As for a code for use in multiplexing, it is desirable to use an orthogonal code such as a Hadamard code, a Zadoff-Chu sequence, or the like. However, in the present invention, there is no particular restriction on the code, and other codes, for example, a quasi-orthogonal code such as an M-sequence may be employed. In hatched resource elements located in a lower right corner, DM-RS's of antenna ports 9, 10, 12, and 14 are code-multiplexed on four resource elements. Note that in a case where the number of transmitting antennas used is equal to or less than two, a data signal is allocated, instead of DM-RS's, in the hatched resource elements located in the lower right corner.

In the present embodiment, when coordinate communication is performed by a plurality of transmission points, the reception apparatus is capable of estimating a channel between each transmission point and the reception apparatus. To achieve this, DM-RS's are orthogonalized among transmitting antennas. Next, mapping of DM-RS's so as to be orthogonal is described below.

First, a method of orthogonalizing DM-RS's among the transmission points without changing mapping of DM-RS's. LTE-A supports use of DM-RS's for up to 8 transmitting antennas by orthogonalizing the DM-RS's using diffusion codes. Therefore, if DM-RS's are coded not such that the DM-RS's are orthogonal among 8 antennas in one particular cell but such that diffusion codes are allocated to antennas including antennas (or layers) of other transmission points, it is possible to orthogonalize DM-RS's among a plurality of transmission points without changing the mapping of DM-RS's. For example, coordination may be performed among 4 cells. In this case, let the 4 cells be denoted by cell 1, cell 2, cell 3, and cell 4. In a case where each of 4 transmission points uses two transmitting antennas, a total of 4 antennas in cell 1 and cell 2 may be allocated in hatched resource elements in the upper right corner, and a total of 4 antennas in cell 3 and cell 4 may be allocated to hatched resource elements in the lower right corner. Because DM-RS's associated with each transmission point are orthogonalized using the diffusion code, the reception terminal is capable of estimating a channel between each transmission point and the reception terminal. Note that the number of transmitting antennas (that is, the number of diffusion codes) and the number of layers may be different among transmission points.

A method described next is to increase the number of resource elements in which it is allowed to map DM-RS's such that orthogonality is achieved using diffusion codes.

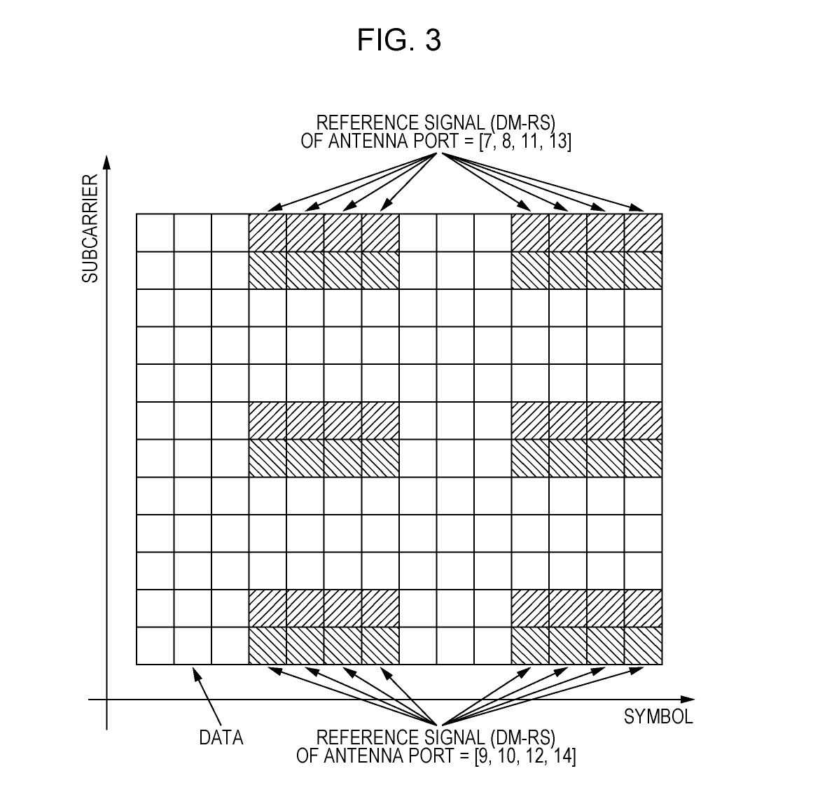

FIG. 3 illustrates an example in which the diffusion code length is set to 8. In this case, it is possible to achieve orthogonality among a total of up to 16 transmitting antennas at coordinate transmission points. When DM-RS's are mapped to all 14 OFDM symbols, it is possible to achieve up to 28-fold multiplexing. The allocation of the hatched resource elements located in the upper right corner and the hatched resource elements located in the lower right corner to antenna ports may be set for each transmitting antenna. For example, for a certain transmission point, DM-RS's for antenna ports=[7, 8, 11, 13] may be mapped to the hatched resource elements in the upper right corner, and DM-RS's for antenna ports=[9, 10, 12, 14] may be mapped to the hatched resource elements in the lower right corner. For another transmission point, DM-RS's for antenna ports=[7, 8, 11, 13] may be mapped to the hatched resource elements in the lower right corner, and DM-RS's for antenna ports=[9, 10, 12, 14] may be mapped to the hatched resource elements in the upper right corner.

Next, a method is described below to achieve orthogonalization also in time and frequency in addition to the diffusion code.

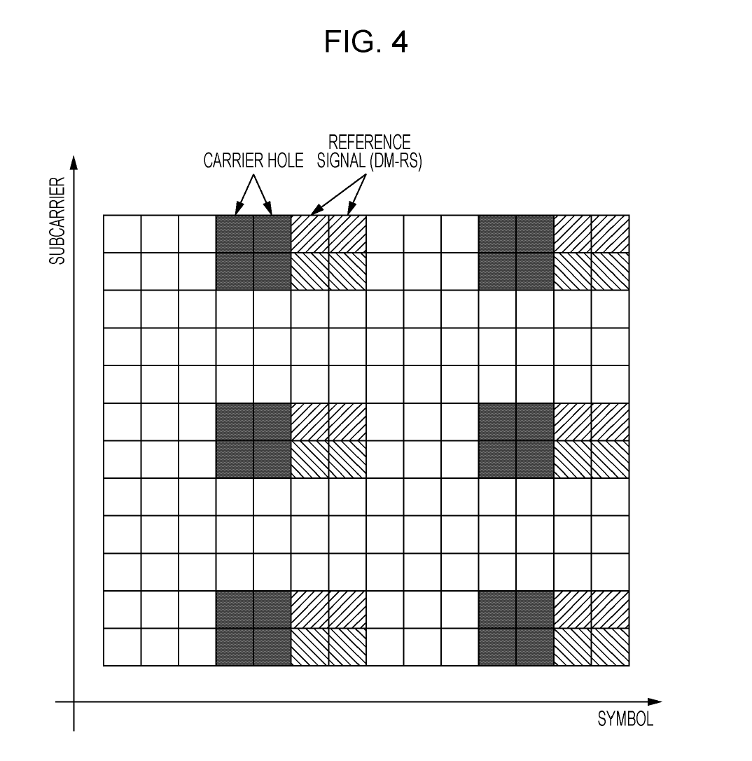

FIG. 4 illustrates an example of a manner of mapping. In FIG. 4, hatched resource elements and unhatched resource elements are similar to those illustrated in FIG. 7. Resource elements shaded in black denote carrier holes, for use by DM-RS's associated with other transmission points. Note that carrier holes are resource elements that are not used to transmit a signal. In other words, transmission power is 0 in these resource elements. Note that the transmission power does not necessarily need to be 0 if the transmission power is low enough not to influence channel estimation or interference estimation. That is, the hatched resource elements in FIG. 4 are not used to map a signal associated with any other coordinate transmission point. To map no signals, modulation symbols may be punctured or the number of modulation symbols may be adjusted in advance by performing rate matching to calculate the number of information bits taking into account resource elements that are not allocated. Note that at least one carrier hole of a transmission point is set as a different resource element. In a case where a sufficiently large number of diffusion codes are available, it is possible to employ code multiplexing with another transmission point. DM-RS allocation information indicating allocation of DM-RS's is transmitted as control information from a base station to a reception terminal. The reception terminal perform the channel estimation according to the received DM-RS allocation information. In FIG. 4, orthogonalization is achieved, by way of example but not limitation, in time. Alternatively, DM-RS's may be allocated such that frequencies are different among transmission points, or such that times and frequencies are different among transmission points. By allocating DM-RS's in different resource elements in the above-described manner, it becomes possible to perform channel estimation independently for each transmission point.

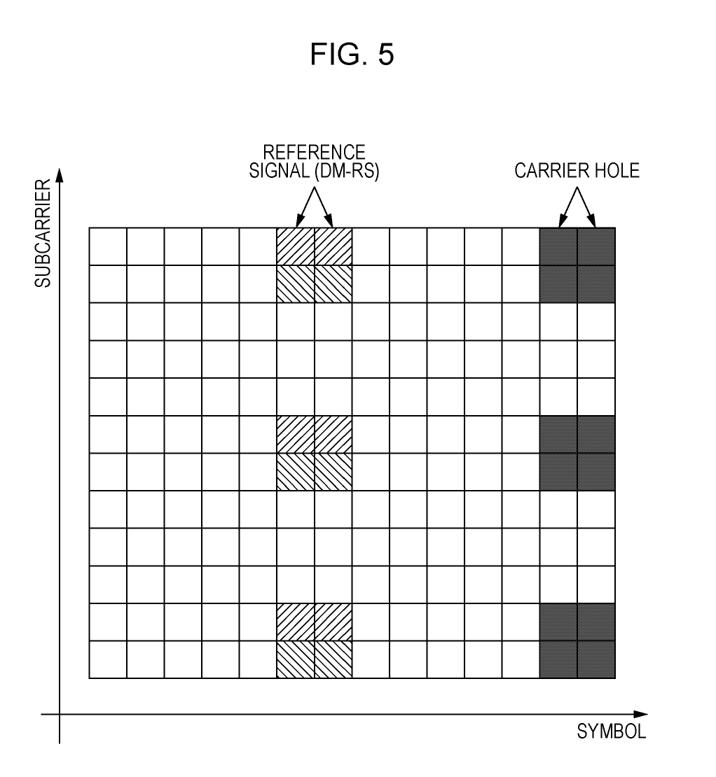

In a next example described below, diffusion codes are shortened thereby generating extra resource elements for use as carrier holes. FIG. 5 illustrates an example in which 13th and 14th symbols are shortened thereby generating extra resource elements for use as carrier holes. In this example, it is possible to achieve orthogonalization for a total of up to 8 transmitting antennas of coordinate transmission points. This makes it possible to orthogonalize DM-RS's among transmission points without using a new resource element.

In a next example described below, hatched resource elements in the upper right corner or hatched resource elements in the lower right corner are set as carrier holes.

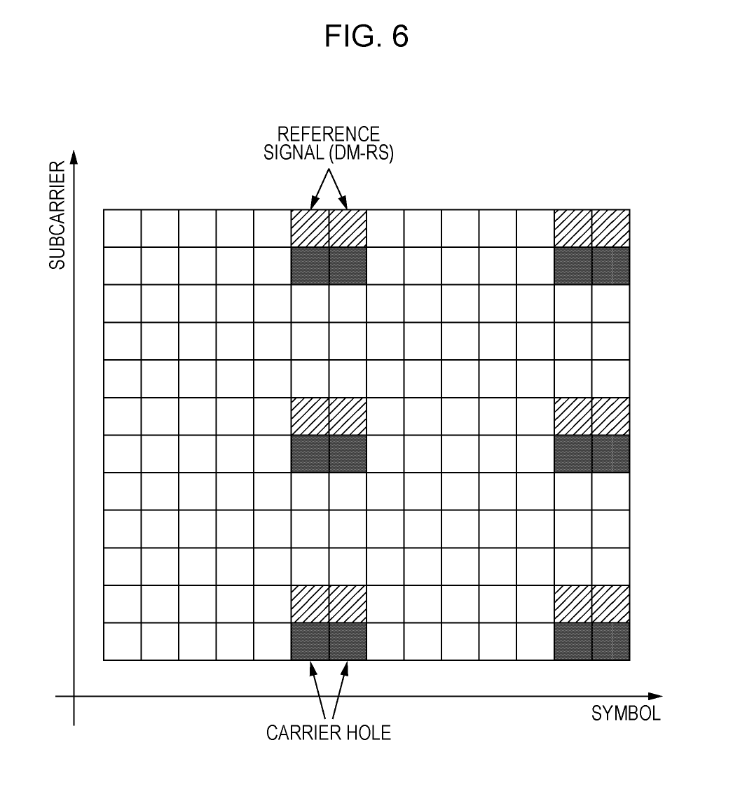

FIG. 6 illustrates an example in which the hatched resource elements in the lower right corner are set as carrier holes. This makes it possible to orthogonalize DM-RS's among transmission points without using a new resource element.

In the embodiment described above, DM-RS's are orthogonalized among transmission points. This makes it possible to estimate a channel between each transmission point and a reception terminal. If a channel estimation value between the reception terminal and each transmission point estimated by the reception terminal is fed back to the transmission point, it becomes possible to use a technique, for example, a coordinated beam forming technique, an interference alignment technique, or the like to suppress interference by coordination among a plurality of transmission points thereby allowing it to improve the cell throughput.

The invention provides a program that is executed on a reception apparatus to control a CPU or the like (to allow a computer to function) to realize functions of the above-described embodiments of the invention. Information treated with by such apparatuses is stored temporarily in a RAM when a process is performed. Thereafter, the information is stored in various ROMs or a HDD, read out by the CPU as required, and modified and written. As for a medium for storing the program, any of the following may be used: a semiconductor medium (for example, a ROM, a nonvolatile memory cord, or the like); an optical storage medium (for example, DVD, MO, MD, CD, BD, or the like); a magnetic storage medium (for example, a magnetic tape, a flexible disk, or the like) or the like. Not only the functions of the embodiments described above are realized by executing the loaded program, but the functions of the invention may also be realized by performing a process in cooperation with an operating system or another application program or the like according to an instruction of the program.

To distribute the program in market, the program may be stored in a portable storage medium and distributed, or the program may be transferred to a server computer connected via a network such as the Internet or the like. In this case, a storage apparatus of the server computer also falls within the scope of the present invention. Part or all of the mobile station apparatus and the base station apparatus according to the embodiments described above may be realized by an LSI which is a typical integrated circuit. The functional blocks of the reception apparatus may be individually realized on different chips, or part or all of functional blocks may be integrated on a chip. In the case where the respective functional blocks are realized in integrated circuits, an integrated circuit control unit may be additionally provided to control the integrated circuits.

The method of realizing the integrated circuit is not limited to the LSI, but the functions may be implemented by a dedicated circuit or general-purpose processor. If the progress of the semiconductor technology provides a technology for implementing an integrated circuit which replaces the LSI, the integrated circuit based on this technology may also be used.

While the embodiments of the present invention have been described in detail with reference to the drawings, the invention is not limited to the details of the embodiments, and modified designing or the like is possible without departing from the sprit and scope of the invention. Note that such modified designing or the like also falls within the scope of the invention.

### REFERENCE SIGNS LIST

101 scrambling unit
102 modulation unit
103 layer mapping unit
104 precoding unit
105 reference signal generation unit
106 resource-mapping unit
107 OFDM signal generation unit
108 radio unit
109 transmitting antenna
201 receiving antenna
202 radio unit
203 CP removal unit
204 FFT unit
205 channel estimation unit
206 signal detection unit
207 demodulator
208 descrambling unit

1-10. (canceled)

11. A reception apparatus that communicates with a transmission point, configured to receive a first reference signal that is a user-specific reference signal transmitted by the transmission point that the reception apparatus commutates with, determine a first channel estimation value between the transmission point and the reception apparatus by using the first reference signal, and transmit the channel estimation value to the transmission point that the reception apparatus commutates with.

12. The receiving apparatus according to claim 11, wherein the receiving apparatus is configured to receive signals transmitted by a plurality of transmission points, receive in addition to the first reference signal a second reference signal that is a user-specific reference signal transmitted by a transmission point other than the transmission point that the receiving apparatus communicates with, determine a second channel estimation value between the receiving apparatus and the transmission point other than the transmission point that the receiving apparatus communicates with by using the second reference signal, and transmits the first channel estimation value and the second channel estimation value to the transmission point that the receiving apparatus communicates with.

13. The receiving apparatus according to claim 12, wherein the receiving apparatus is configured to receive a signal on which the first reference signal and the second reference signal are code-multiplexed.
